(19) United States
(12) Patent Application Publication
(10) Pub. No.: US 2007/0089616 A1
(43) Pub. Date: Apr. 26, 2007

(54) Raisin seed extractor

(76) Inventor: Jean Michel Cortiade, Francon (FR)

Correspondence Address: EGBERT LAW OFFICES, 412 MAIN STREET, 7TH FLOOR, HOUSTON, TX, 77002, US

(21) Appl. No.: 10/570,359

(22) PCT Filed: Aug. 24, 2004
(86) PCT No.: PCT/EP04/51884

§ 371 Date: Oct. 21, 2006

(30) Foreign Application Priority Data
Sep. 3, 2003 (FR) 0310401

(51) Int. Cl. A23N 4/12

(52) U.S. Cl. 99/547

(57) ABSTRACT

The inventive raisin or grape seed extractor is used for a product made of crushed and destemed raisins or grapes which are introduced in a fast-rotating perforated conical drum for pressing the product; and a worm screw which is arrange inside the drum and turns slightly slow for controlling the forwarding of the product which penetrates in the top part of a cylindrical perforated separation drum arranged on the same geometrical axis that the other drum which is slightly tilted with respect to a horizontal line and turns slowly, thereby passing the seeds through perforations. The treated product is removed through the lower end and a spout towards fermenting tanks, the seeds being removed through an opening by the worm screw. The term “raisin”, translated from French, is understood to be raisins or grapes in English.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention concerns an extractor of raisin seeds from a product consisting of crushed and de-stemmed raisins that have been prepared for in-vat fermentation during wine-making.

### BACKGROUND OF THE INVENTION

The presence of raisin seeds during in-vat fermentation for wine-making transmits to the wine produced by this fermentation certain undesirable final taste and nose characteristics that become more pronounced the stronger the concentration of seeds. Removal of all or part of the seeds is of very great interest for improving the quality of certain “grand crus” and of certain ordinary wines.

Extracting these seeds is difficult due to the fact:
that these seeds have pretty much the same density as the surrounding blend;
that for certain raisin varieties the fruit pulp clings to the seeds and that it is imperative to reintegrate this pulp into the blend for fermentation purposes; and
that crushing the raisins prior to their introduction into the fermentation vat must be made in a such a manner that the seeds are not smashed which would aggravate the noxious effect of their presence.

Consequently one cannot completely dissociate pulp, raisin skin, seeds in order to achieve easy elimination of the latter.

The apparatuses currently used in vinification for seed extraction operate on a general principle known under the name of load lightening. It consists, during the fermentation phase, of periodically drawing off the liquid part of the tank, a small quantity of seeds that are carried along by the liquid is extracted, on the one hand by sieving, and on the other hand by trapping grids at the bottom of the vat which allow extracting another small quantity of seeds. Most of the seeds however remain caught in the substrate at the bottom of the tank. Various methods are used to smash this substrate before and during reintroducing the liquid into the tank, either by mechanical action on this substrate or by hydraulic effect resulting from the impact of the brutal drop of the liquid or from a liquid jet on this substrate. These operations must be repeated once or twice every day during the fermentation phase and represent a significant constraint.

### BRIEF SUMMARY OF THE INVENTION

The extractor of this invention is integrated in the preparation and handling chain of the product to be fermented prior to its introduction into the fermenting tank. In this case it delivers a result that is sufficient for certain raisin varieties. For other varieties more difficult to process, the extractor needs to be used after fermentation has started and which will have further separated pulp and seeds. In this case it will be necessary, after drawing off of the liquid, to extract the substrate from the tank to make it undergo the treatment by the extractor which is the subject of this invention, before reintroducing it into the tank for further fermentation. This operation however takes place only one time at the most best over the length of the fermentation.

The extractor takes up the flow of product constituted of the raisins resulting from the vine-harvest from the vineyards, and which have been treated in a chain of preparation and handling after the raisins have been crushed and the stalks removed (de-stalking or de-stemming).

The extractor combines in a single apparatus the execution of two successive treatment phases, draining and separation, presenting the advantage of introducing and recovering the product only once, the internal transit from one phase to the other taking advantage of the speeds and flow of the product at the exit of the upstream phase in order to smoothly provide the following phase, whereby the degradation of the very delicate product treated in this case is being reduced in a very appreciable manner.

The Extractor includes on a single geometric axis, slightly tilted with respect to the horizontal, two rotating drums:
a perforated draining drum rotating at high speed to remove the maximum amounts of liquid from the product; and
a perforated separator drum which extracts the seeds. This drum exists in two rapidly interchangeable versions which differ only in the shape of the perforations, depending on the characteristics of the product to be treated.

### BRIEF DESCRIPTION OF THE SEVERAL VIEWS OF THE DRAWINGS

FIGS. 1 and 2 represent schematic front and side views of a design of the seed extractor which is the subject of this invention.

### DETAILED DESCRIPTION OF THE INVENTION

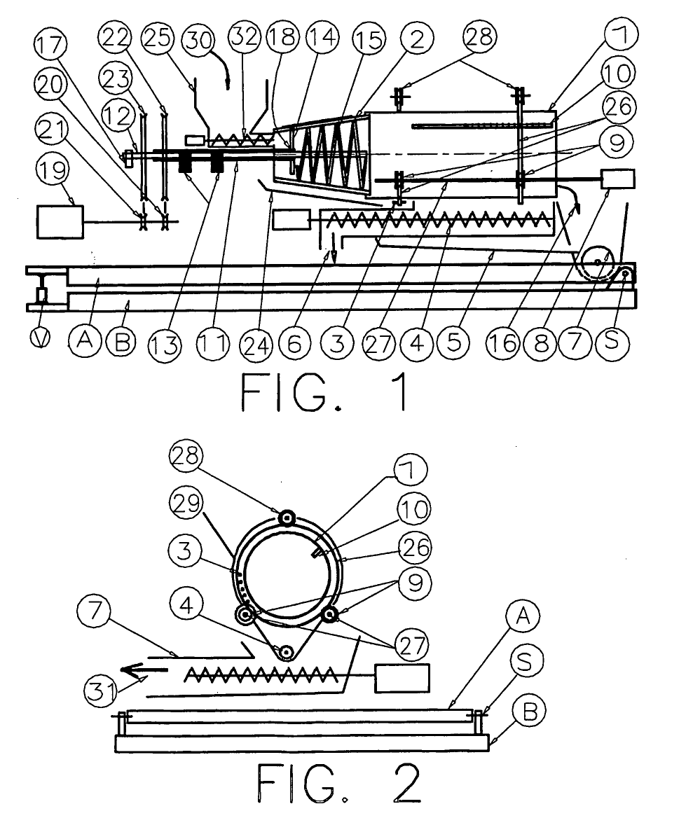

Referring to FIG. 1, the drain drum 2 of truncated (tapered) shape is made of perforated sheet metal with round or oblong holes of a size less than 2 mm, allowing the passage of the liquid mixed in the product, the sheet metal being rolled in a truncated cone of a circular section with an essentially horizontal axis xx′, total angle at the top of the cone being about 16 to 20 degrees. On the small base, the sheet metal of the cone is smooth, not perforated over a short length following the generating lines. The product, arriving via 30 in the chute 25 is pushed by the worm screw 32 to the inside of the cone trunk of the drain drum 2 on the smooth part of the small base side, falls there onto the inside wall rotating at high speed and, under the effect of friction on the smooth part, is progressively assuming the speed of the drum. Under the combined effect of centrifugal force and of the cone angle (taper) of the drum the product will progress towards the large base of the cone of the drain drum 2. The purpose of the smooth part is to make the product slide more easily along the circumference of the drum in order to avoid its being drawn too rapidly into rotation thus diminishing its deterioration. Support arms 14 of this drum are located downstream of the smooth part. The product will pass between them to arrive in the perforated area. The centrifugal force will activate the separation of the liquid which will evacuate through the perforations. In order to control the product's progression towards the exit, a worm screw 15, fitted to the inside wall of the cone of the drain drum 2, rotates with the latter at a slightly lower speed so that it pushes the product towards the large base of the drum's cone. By acting on the speed difference between the drain drum 2 and worm screw 15, the output of the apparatus and the drain rate are regulated in a not independent manner. The liquid components are collected in the low portion under the drain drum 2 by a collector 24 and are directed towards the exit of the apparatus. A fixed sheet metal housing (not shown) encloses the drain drum 2 in order to collect the droplets projected by the centrifugal force and lets them fall to the lower part in the collector 24.

The separator drum consists of sheet metal that is perforated with round holes with a 7 to 8.5 mm diameter, depending on the raisin varieties. These holes are either ordinary, arranged in a zig-zag pattern at a distance of approximately 11 mm for fruit with pulp clinging to the seed, or at the same distance and drilled from the inside to the outside so as to obtain a rounded chamfer on the inside and possibly a burr on the outside. This separator drum 1 has a diameter that is slightly larger than that of the drain drum 2 and overlaps it slightly in order to recover, without any losses, the product exiting the drain drum 2 and projected tangentially with respect to its circumference by the centrifugal force. In order not to degrade this product arriving at high speed, the portion of the separator drum 1 in this receiving area is smooth without any perforations over a length of about 0.15 to 0.30 meters, depending on the length of generating lines. The product, driven by a tangential movement in relation to the drain drum 2, slides in a rotating manner on the inside part of the separator drum 1 which turns much more slowly, and slows down due to friction without deteriorating.

The common axis xx′ of the drums is slightly tilted on the horizontal, the exit being lower than the entrance. This has no appreciable bearing on the drain drum 2 considering its high speed, whereas in the separating drum 1, given its low rotational speed, the product does not remain stuck to the wall but slides partially and falls back before reaching the upper part of the drum. Due to the sieve effect the seeds pass through the holes of separating drum 1, the rest of the product retained inside the drum including essentially the skin and the pulp of the raisins is evacuated towards the lower part, the faster the steeper the slope. By adjusting this slope one sets the retention time in this separating drum 1 and also the output and the rate of extracted seeds. For low outputs or raisin varieties that are easy to process the working length of the perforated part of separating drum 1 is being reduced by lining the inside wall of this drum on the exit side with a thin and smooth detachable metal sheet of cylindrical shape. The length of this detachable cylinder is adapted in accordance with the length of the perforated part to be left open and functional. This detachable cylinder is formed by a rectangular piece of sheet metal that is rolled up and not welded so that when it is removed from the separating drum 1, it re-assumes its original flat shape and takes up less space. A set of several metallic sheets is thus formed to provide different lengths of detachable cylinders. They are attached to the inside of the separating drum 1 with a few bolts using the drum perforations. This method avoids, in these last cases indicated, an exaggerated tilting of the drum axis and may cause needless rubbing and deterioration of the product which has been sufficiently treated on the perforated parts of separating drum 1. For all separating drums 1 the separations between the perforated and the smooth parts, including for the detachable sheet, are located in the planes perpendicular to the axis that is common to the drums. A baffle 10 consisting of a blade that is about 3 to 5 cm high and placed in line following a generating line of the separating drum 1 inside the latter and in its perforated part, on the one hand catches a portion of the product as it passes to the low position, pulls it higher during the rotation before it drops in free fall so that it becomes periodically detached instead of letting it constantly slide against the wall. On the other hand, it prevents the product from gathering in a twisted mass rotating in the low part of the separating drum 1 which would hamper the operation.

A stationary housing (not shown) encloses the cylindrical part of the separating drum 1 in order to collect the seeds in the low part. They are removed by a classic worm screw system 4 towards the outside of the extractor at 6.

Additional characteristics will appear in the description of a particular execution below.

With reference to FIGS. 1 and 2, the drain drum 2 consists of sheet metal of a thickness of 1.5 mm that is perforated with holes of a diameter of 2 mm and which has been rolled to form a hollow truncated cone of a length of 1 meter and a large diameter of 0.80 m and a small diameter of 0.50 m. On the small diameter side, the sheet metal is not perforated over 0.15 m, following the generating lines of the cone, it is supported by a rotating hollow shaft 11 of an outside diameter of 90 mm which is itself driven by:
the adjustable speed motor 19 incorporated in frame A,
the set of reducing sheaves 20 and 22, and
a V-belt connecting these sheaves.

The shaft 11 is supported by the bearings 13 attached to the general frame A, three arms 14 located in a plane perpendicular to shaft 11 connect the latter to the truncated cone of the drain drum 2, they are bolted to a circular metal ring fastened to the outside of the drain drum 2 near the transition from the smooth to the perforated part. On the large diameter side, the drain drum is supported by three rollers that are radially placed at 120° in relation to the axis of the drain drum 2 and attached to frame A, they roll on a ring made of flat rolled iron 6×40 with an inside diameter of 0.80 m, welded to the large diameter end of the truncated perforated wall of the drain drum 2, the outside face is the running tread of aforementioned rollers. The worm screw 15 consists of a flat bar iron with a section of 5×80 mm curved in the field into 5 devolutions following the interior shape of the cone of drain drum 2 with a play of 1 mm. Convoluted so that when it turns in the opposite direction to the drum 2, it pushes the product that is trapped between its devolutions towards the large base of this drum, it is connected by arms to the shaft 12 concentric to shaft 1 1, its rotation is driven by motor 19 and the set of reducing sheaves 23 are identical to 22 and 21. The latter having an adjustable flange spacing, provide a reducing ratio slightly greater than that of the set of sheaves 20 22, this shaft is supported by the bearing 17 attached to the general frame A and by the bearing 18 located between shaft 12 and the inside of shaft 11.

This drain drum 2 is supplied through the chute 25 penetrating slightly to the outside of this drum on the small base side. This chute contains at the bottom a worm screw 32 to feed the drain drum 2 and is attached to the general frame A. A stationary housing, (not shown) that is attached to frame A, surrounds the drain drum 2 to collect the fragments of liquids extracted by this drum and makes them drip into the collector 24. The latter is made of sheet metal which surrounds on the outside the lower half of drum 2 with a space of 0.10 m between the two. It includes an interior shoulder on the large diameter side to stop the collected liquid. It is attached on frame A and includes at its lowest part a horizontal cross pipe for the evacuation of liquid gathered in the recovery collector 7 towards the downstream side of the Extractor.

The separating drum 1 consists of sheet metal with a thickness of 1 mm and is perforated with holes which are flared on the inside but narrower towards the outside, with a diameter of 8 mm. The sheet metal is shaped so as to form a cylinder with a diameter of 0.90 m and a length of 2 m. It includes a 20 mm interior circular shoulder at the infeed end adjacent to a smooth part without holes over 0.15 m length following the generating lines extending through the perforated part all the way to the other end which will be the outfeed side. Inside, the baffle consists of a flat iron with a section of 10×35 mm, attached in the field following a generating line of the cylinder covering the active, perforated part of the separating drum 1. On the outside the perforated cylinder is reinforced by 2 circular rings 26 of 10×40 mm flat iron with an inside diameter equal to the outside diameter of the cylinder and attached by spot welds on the latter perpendicular to the generating lines and at 0.40 meter from each end. These rings are used to support the drum and to provide its rotation at the speed of 17 RPM.

A second identical drum 1 is manufactured but out of perforated sheet metal with ordinary holes of 8 mm diameter and not flared as in the previous drum.

The separating drum 1 rests on 4 rollers 9 with a diameter of 0.12 m by way of the rings 26 (2 rollers per ring). Each roller has a 12 mm wide U-shaped groove in which runs a ring 26. These rings are fastened in pairs to a shaft 27 with a diameter of 25 mm, turning on bearings that are attached to frame A and driven by a motor 8. Two identical shafts 27 are attached to the frame A so that the rings 26 are engaged in the U-shaped grooves of the rollers 9. These shafts parallel to the generating lines situated in the low part of the separating drum 1 are seen at an angle of 90 degrees each other from the common drum axis. The ring 26, on the infeed side, features on its median circumference approximately ninety-seven cylindrical pins 3 with a diameter of 10 mm, a length of 40 mm, parallel to the generating lines of the separating drum 1, evenly spaced at 31.75 mm and extending equally on both sides from the corresponding ring, each of the sidewalls of one of the rollers 9 of each shaft 27 comprises teeth that are cut so as to form a toothed sprocket that engages in the pins 3 to improve the drive of the separating drum 1, a third identical shaft 28 without a motor is positioned at the upper generating line of the separating drum 1 to complete the guidance by an additional roller (not shown) on each ring 26. A casing 29 of 1 mm thickness sheet metal surrounds the assembly over the length corresponding to the perforated part of the separating drum 1, this casing 29 and the bearings of shaft 28 are supported together by two crossbraces bolted to the frame A in order to facilitate changing the separating drums 1 depending on the variety of raisins to process. The casing 29 at the lower part discharges into a chute with a worm screw parallel to the axis of the drums to evacuate the seeds to the outside at 6. The lower part of this chute features perforations to let the residual liquid recovered from the collector 5 pass through. The housing 29 includes, in its lower part, sidewalls that are tilted at 45° to connect to the spout of the chute. At the outfeed 16 of separating drum 1, a chute 7 with a worm screw receives the treated seedless product in order to reintegrate it at 31 into the conventional processing line. This chute also collects the liquid outflows from collectors 24 and 5. The frame A supporting the above assembly rests on another frame B placed on the floor. The frames A and B are hinged around a shaft S whose axis on the outfeed side of the separating drum 1 is perpendicular to the axis of this drum. On the side opposite to shaft S, the frame A is raised or lowered with respect to frame B by a jackscrew V which allows adjustment of the incline of the common rotational axis of drums 1 and 2 thereby allowing to control the flow and the rate of seed extraction of the separating drum 1.

The Extractor is usable for the production of wine in order to improve its quality and to reduce handling operations.

I claim:

1. Raisin or Grape seed extractor for continuous removal of seeds contained in a product comprised of crushed raisins or grapes intended for fermentation for wine-making, the extractor comprising:
a perforated drain drum at an infeed with an essentially horizontal axis rotating at high speed so as to extract liquid parts of the product by centrifugal force;
a worm screw controlling progression of the product inside said drain drum and being able to evacuate the product into a perforated separating drum rotating at low speed, having perforation for the seeds to pass therethrough to fall into a chute (4); and
a means removing the seeds, the treated product being retained inside said separating drum and exiting at an end opposite to the infeed.

2. Extractor according to claim 1, further comprising:
ajackscrew able to modify an incline of a geometric axis of said separating drum so as to adjust processing time and rate of seed extraction.

3. Extractor according to claim 1, wherein said separating drum has a smooth area at the infeed thereof so as to collect and slow down without damaging said product, said product to be treated arriving at high speed.

4. Extractor according to claim 1, further comprising:
a perforated sheet metal of the separating drum having holes and being flared on an inside of the separating drum, said holes being smaller towards an outside where a burr is formed.

5. Extractor according to claim 1, wherein said drain drum has a smooth area on an inside part at the infeed thereof, rotating at high speed to receive the product which has an initial speed of zero and bringing the product without damaging or shocking the product up to high operating speed of a perforated downstream portion of said drain drum.

6. Extractor according to claim 1, further comprising:
a worm screw matching an inside shape of said drain drum, rotating at a different speed from said drain drum in order to continuously expel the product.

7. Extractor according to claim 6, further comprising:
a fixed system of sheaves; and
one system of sheaves with a variable diameter regulating speed differential between said drain drum and said worm screw controlling product flow.

8. Extractor according to claim 1, further comprising:
a set of smooth cylindrical detachable metal sheets lining the perforated inside wall of said separating drum to adapt length of the perforated portion to characteristics of the product to be processed.

9. Extractor according to claim 1, further comprising:
an interior baffle in said separating drum, following a generating line of said separating drum and having a perforated portion which periodically breaks up the product to facilitate release of the seeds and to prevent formation of spiral-shaped product.

10. Raisin or Grape seed extractor according to claim 1 wherein said drain drum is truncated.
